(19) United States
(12) Patent Application Publication
(10) Pub. No.: US 2009/0265148 A1
(43) Pub. Date: Oct. 22, 2009

(54) MODELING A SECTOR-POLARIZED-ILLUMINATION SOURCE IN AN OPTICAL LITHOGRAPHY SYSTEM

(75) Inventors: Qiaolin Zhang, Mountain View, CA (US); Hua Song, San Jose, CA (US)

Correspondence Address: PVF -- SYNOPSYS, INC;c/o PARK, VAUGHAN & FLEMING LLP, 2820 FIFTH STREET, DAVIS, CA, 95618-7759, US

(73) Assignee: Synopsys, Inc., Mountain View, CA (US)

(21) Appl. No.: 12/104,122

(22) Filed: Apr. 16, 2008

(51) Int. Cl. G06G 7/62; G06F 17/10

(52) U.S. Cl. 703/2

(57) ABSTRACT

One embodiment of the present invention provides a system that constructs a source polarization model to simulate a piecewise-constant-linear polarization-configuration of an illumination source in an optical lithography system. During operation, the system starts by partitioning an illumination pupil plane of the illumination source into a set of sectors to match a physical implementation of the illumination source. Next, the system constructs the source polarization model for the illumination source by individually specifying a constant-linear polarization-state within each sector to match the polarization-configuration of the illumination source.

### RELATED APPLICATION

The subject matter of this application is related to the subject matter in a pending non-provisional application by the same inventors as the instant application and filed on 6 Sep. 2007 entitled, “Modeling an Arbitrarily Polarized Illumination Source in an Optical Lithography System,” having Ser. No. 11/851,021 (Attorney Docket No. SNPS-0986-2)

### BACKGROUND

1. Field of the Invention

The present invention generally relates to semiconductor manufacturing and modeling for semiconductor manufacturing process. More specifically, the present invention relates to a method for constructing a lithography and Optical Proximity Correction (OPC) model to simulate a sector-polarized illumination source in an optical lithography system used in a semiconductor manufacturing process.

2. Related Art

Dramatic improvements in semiconductor integration circuit (IC) technology presently make it possible to integrate hundreds of millions of transistors onto a single semiconductor IC chip. These improvements in integration densities have largely been achieved through corresponding improvements in semiconductor manufacturing processes. Semiconductor manufacturing processes typically include a number of operations which involve complex physical and chemical interactions. Since it is almost impossible to find exact formulae to predict the behavior of these complex interactions, developers typically use process models which are fit to empirical data to predict the behavior of these processes. In particular, various process models have been integrated into Optical Proximity Correction (OPC)/Resolution Enhancement Technologies (RET) for enhancing imaging resolutions during optical lithographic processes.

As Moore's Law drives IC features to increasingly smaller dimensions (which are now in the deep submicron regime), a number of physical effects, which have been largely ignored or oversimplified in existing OPC/RET models, are becoming increasingly important for OPC/RET model accuracy. In particular, as the IC industry begins using 65 nm-node and even smaller processes, choosing a proper illumination and polarization configuration for the illumination source of an optical lithography system has become an important methodology for enhancing the contrast of projected image on the wafer, and hence the mask pattern printability. Among different types of polarized illumination sources, a TE (transverse electric)-polarized illumination source is desirable because such an illumination source can facilitate achieving high image intensity contrast (which is partially due to the excellent interference properties of TE-polarized light). However, an ideal TE illumination source is almost impossible to implement due to hardware limitations. As a result, only an approximated version of an ideal TE illumination source has been physically realized in an optical lithography system.

Unfortunately, due to a lack of knowledge about how lithography system manufacturers physically implement an approximated TE illumination source on the scanner, existing OPC/RET models treat the entire illumination source as an ideal TE-polarized illumination source, which assumes that the electric field is in the azimuthal direction and perpendicular to the local radial direction. Because the ideal TE-polarized illumination assumed by these OPC/RET models does not mathematically match the physical implementation of the TE illumination on a real scanner, the accuracy of OPC/RET models for these advanced processes (when TE-polarized illumination is used) is severely impaired.

Hence, what is needed is a method and an apparatus that can accurately model the physical implementation of a TE-polarized illumination source without the above-described problems.

### SUMMARY

One embodiment of the present invention provides a system that constructs a source polarization model to simulate a physical implementation of a transverse electric (TE)-polarized illumination source in an optical lithography system. During operation, the system starts by partitioning an illumination pupil plane of the illumination source into a set of sectors to match a physical implementation of the illumination source. Next, for each sector, the system defines a constant-linear polarization angle which is substantially perpendicular to a radius bisecting the sector. The system then provides an imaging formulation for each sector based on the corresponding linear polarization angle in that sector.

In a variation on this embodiment, the system partitions the illumination pupil plane of the illumination source by partitioning the illumination pupil plane into four substantially equal circular sectors.

In a further variation on this embodiment, the system defines a constant-linear polarization state for each of the four substantially equal sectors by (1) defining x-polarization states for the pair of opposing circular sectors on Y-axis and (2) defining y-polarization states for the pair of opposing circular sectors on X-axis.

In a variation on this embodiment, the system partitions the illumination pupil plane of the illumination source by partitioning the illumination pupil plane into eight substantially equal circular sectors.

In a variation on this embodiment, the system increases the number of sectors in the partition to better approximate an ideal TE-polarized illumination source.

In a variation on this embodiment, the system incorporates the source polarization model for the illumination source into a lithography model for the optical lithography system or for Optical Proximity Correction (OPC).

In a further variation, the system incorporates the source polarization model into the lithography model by (1) computing the effect from each sector in the source polarization model on the lithography model and (2) combining the computed effects of the set of sectors into the source polarization model.

Another embodiment of the present invention provides a system that constructs a source polarization model to simulate a physical implementation of a transverse magnetic (TM)-polarized illumination source in an optical lithography system. During operation, the system starts by partitioning an illumination pupil plane of the illumination source into a set of sectors to match a physical implementation of the illumination source. Next, for each sector, the system defines a constant-linear polarization angle which is substantially parallel to a radius bisecting the sector. The system then provides an imaging formulation for each sector based on the corresponding linear polarization angle in that sector

Another embodiment of the present invention provides a system that constructs a source polarization model to simulate a piecewise-constant-linear polarization-configuration of an illumination source in an optical lithography system. During operation, the system starts by partitioning an illumination pupil plane of the illumination source into a set of sectors to match a physical implementation of the illumination source. Next, the system constructs the source polarization model for the illumination source by individually specifying a constant-linear polarization-state within each sector to match the polarization-configuration of the illumination source.

In a variation on this embodiment, partitioning the illumination pupil plane of the illumination source into a set of sectors can involve a radial-sector partition, a circular-sector partition, or other partitions with specific sector shape and positioning.

In a variation on this embodiment, the piecewise-constant-linear polarization-configuration of the illumination source can include an approximated TE-polarization-configuration, an approximated TM-polarization-configuration, and any other piecewise-constant-linear polarization-configuration.

In a variation on this embodiment, the system specifies a constant-linear polarization-state within each sector by first specifying a linear polarization angle within the sector. The system then provides a mathematical representation for a linear polarization state within the sector based on the linear polarization angle.

In a variation on this embodiment, the system incorporates the source polarization model for the illumination source into a model for the optical lithography system or for Optical Proximity Correction (OPC).

In a further variation, the system incorporates the source polarization model into the model by (1) computing the effect from each sector in the source polarization model on the lithography model and (2) combining the computed effects of the set of sectors in the source polarization model.

Another embodiment of the present invention provides a system that constructs a model to simulate an arbitrary illumination and polarization-configuration of an illumination source in an optical lithography system. During operation, the system starts by partitioning an illumination pupil plane of the illumination source into a set of sectors to match the shape of the physical implementation of the illumination source. Next, the system constructs the model for the illumination source by individually specifying an illumination polarization-state within each sector to match the illumination and polarization-configuration of the illumination source.

In a variation on this embodiment, the illumination-state within each sector can include: a linear polarization state; a partial polarization state; or an unpolarized state.

In a variation on this embodiment, partitioning the illumination pupil plane of the illumination source into a set of sectors can involve a radial-sector partition, a circular-sector partition, or other partitions with specific sector shape and positioning.

### BRIEF DESCRIPTION OF THE FIGURES

FIG. 1 illustrates various steps in the design and fabrication of an integrated circuit in accordance with an embodiment of the present invention.

FIG. 2 illustrates a typical optical lithography system in accordance with an embodiment of the present invention.

FIG. 3A illustrates an illumination-source model representing an ideal TE-polarized illumination.

FIG. 3B illustrates an approximated TE-polarized illumination source implemented by some scanner manufacturers.

FIG. 4A illustrates the process of constructing a source polarization model to simulate the approximated TE-polarized illumination source in accordance with an embodiment of the present invention.

FIG. 4B illustrates the process of constructing a source polarization model to simulate an approximated TE-polarized illumination source having eight sectors in accordance with an embodiment of the present invention.

FIG. 5 illustrates the process of constructing a source polarization model to simulate an approximated TM (transverse magnetic)-polarized illumination source in accordance with an embodiment of the present invention.

FIG. 6 presents a flowchart illustrating the process of modeling a piecewise-constant polarization-configuration of an illumination source in accordance with an embodiment of the present invention.

FIG. 7 illustrates the process of constructing a source polarization model to simulate an illumination source comprising both linear polarized and unpolarized regions in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

### Integrated Circuit Design Flow

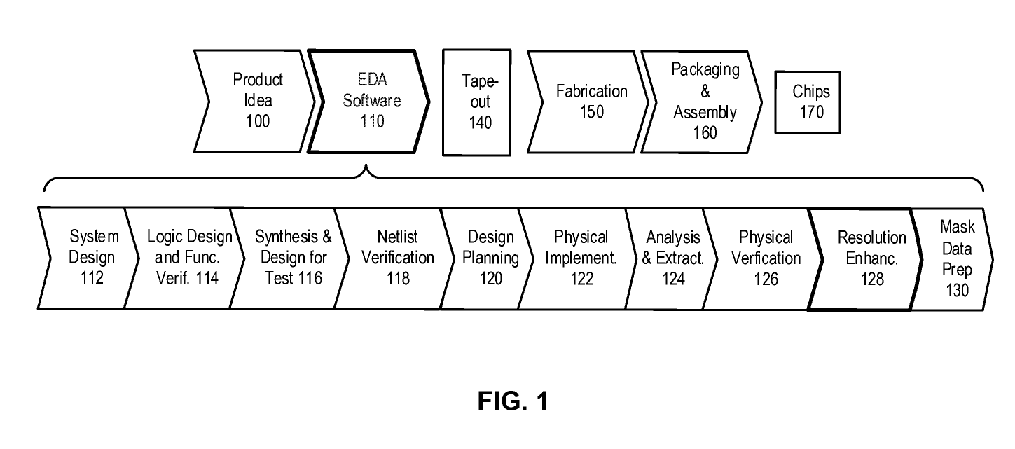

FIG. 1 illustrates various steps in the design and fabrication of an integrated circuit in accordance with an embodiment of the present invention.

The process starts with the product idea (step 100) which is realized using an EDA software design process (step 110). When the design is finalized, it can be taped-out (event 140). After tape out, the fabrication process (step 150) and packaging and assembly processes (step 160) are performed which ultimately result in finished chips (result 170).

The EDA software design process (step 110), in turn, comprises steps 112-130, which are described below. Note that the design flow description is for illustration purposes only. This description is not meant to limit the present invention. For example, an actual integrated circuit design may require the designer to perform the design steps in a different sequence than the sequence described below. The following discussion provides further details of the steps in the design process.

System design (step 112): The designers describe the functionality that they want to implement. They can also perform what-if planning to refine functionality, check costs, etc. Hardware-software architecture partitioning can occur at this stage. Exemplary EDA software products from Synopsys, Inc. that can be used at this step include Model Architect, Saber, System Studio, and DesignWare® products.

Logic design and functional verification (step 114): At this stage, the VHDL or Verilog code for modules in the system is written and the design is checked for functional accuracy. More specifically, the design is checked to ensure that it produces the correct outputs. Exemplary EDA software products from Synopsys, Inc. that can be used at this step include VCS, VERA, DesignWare®, Magellan, Formality, ESP and LEDA products.

Synthesis and design for test (step 116): Here, the VHDL/Verilog is translated to a netlist. The netlist can be optimized for the target technology. Additionally, tests can be designed and implemented to check the finished chips. Exemplary EDA software products from Synopsys, Inc. that can be used at this step include Design Compiler®, Physical Compiler, Test Compiler, Power Compiler, FPGA Compiler, Tetramax, and DesignWare® products.

Netlist verification (step 118): At this step, the netlist is checked for compliance with timing constraints and for correspondence with the VHDL/Verilog source code. Exemplary EDA software products from Synopsys, Inc. that can be used at this step include Formality, PrimeTime, and VCS products.

Design planning (step 120): Here, an overall floorplan for the chip is constructed and analyzed for timing and top-level routing. Exemplary EDA software products from Synopsys, Inc. that can be used at this step include Astro and IC Compiler products.

Physical implementation (step 122): The placement (positioning of circuit elements) and routing (connection of the same) occurs at this step. Exemplary EDA software products from Synopsys, Inc. that can be used at this step include the Astro and IC Compiler products.

Analysis and extraction (step 124): At this step, the circuit function is verified at a transistor level; this in turn permits what-if refinement. Exemplary EDA software products from Synopsys, Inc. that can be used at this step include AstroRail, PrimeRail, Primetime, and Star RC/XT products.

Physical verification (step 126): In this step, the design is checked to ensure correctness for manufacturing, electrical issues, lithographic issues, and circuitry. Exemplary EDA software products from Synopsys, Inc. that can be used at this step include the Hercules product.

Resolution enhancement (step 128): This step involves geometric manipulations of the layout to improve manufacturability of the design. Exemplary EDA software products from Synopsys, Inc. that can be used at this step include Progen, Proteus, ProteusAF, and PSMGen products.

Mask data preparation (step 130): This step provides the “tape-out” data for production of masks to produce finished chips. Exemplary EDA software products from Synopsys, Inc. that can be used at this step include the CATS(R) family of products.

Embodiments of the present invention can be used during one or more of the above-described steps. Specifically, one embodiment of the present invention can be used during resolution enhancement step 128.

### Terminology

Throughout the specification, the following terms have the meanings provided herein, unless the context clearly dictates otherwise. The terms “light,” “optical field,” and “electrical field” are used interchangeably to refer to optical radiation emanating from an illumination source of the lithography system. The terms “illumination source,” “illuminator” are used interchangeably to refer to a complex optical system for generating an illumination for photoresist exposure.

### Overview

Existing illumination source models treat the illuminator as either an unpolarized source (i.e., the illuminator is completely unpolarized with the same amount of incoherent x-polarized and y-polarized components) or a single-state (TE/TM/X/Y) uniformly polarized light source. Unfortunately, these models cannot adequately represent a physical illumination source which can have a much more complex polarization state that can vary with location within the illumination source pupil.

Some embodiments of the present invention provide a technique for modeling a physical implementation of a transverse electric (TE)-polarized illumination source in an optical lithography system. More specifically, embodiments of the present invention partition an illumination pupil plane of the illumination source into a set of circular sectors to match a physical partitioning of the illumination source, and subsequently provide a mathematical representation for a constant-linear polarization state within each of the circular sectors to match the TE-polarization-configuration of the illumination source.

Some embodiments of the present invention provide a technique for modeling a physical implementation of a piecewise-constant polarization-configuration of an illumination source in an optical lithography system. More specifically, embodiments of the present invention partition an illumination pupil plane of the illumination source into a set of sectors to match a physical partitioning of the illumination source, and subsequently specify a constant polarization-state within each sector to match the polarization-configuration of the illumination source.

Some embodiments of the present invention provide a technique for modeling an arbitrary polarization-configuration of an illumination source in an optical lithography system. More specifically, embodiments of the present invention partition an illumination pupil plane of the illumination source into a set of sectors to match a physical partitioning of the illumination source, and subsequently specify a polarization-state within each sector to match the polarization-configuration of the illumination source.

### Optical Lithography System

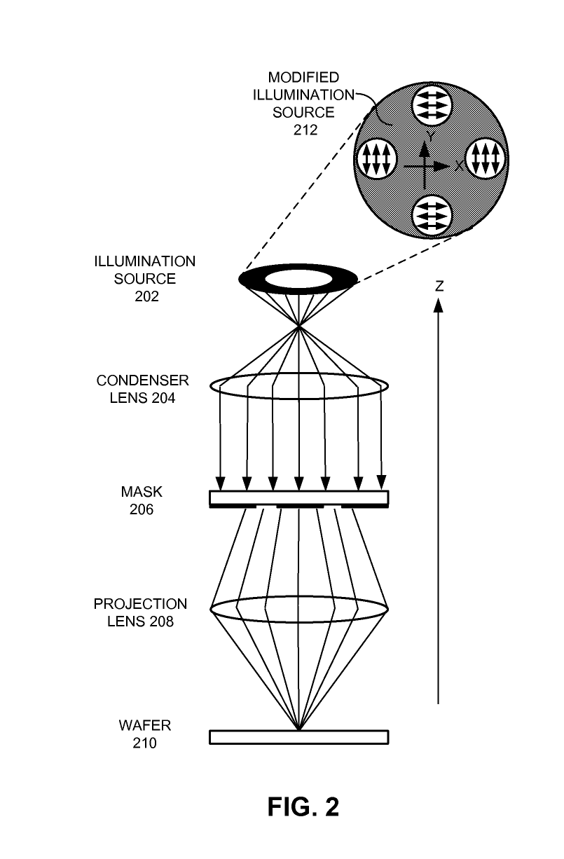

FIG. 2 illustrates a typical optical lithography system in accordance with an embodiment of the present invention. As shown in FIG. 2, optical radiation emanates from an illumination source 202, which can include any suitable physical light source, such as a laser, and can include optical components for converting the light source into an illumination for photoresist exposure. This optical illumination passes through a condenser lens 204, and then through a mask 206. Mask 206 defines integrated circuit patterns to be printed (i.e., fabricated) onto a wafer 210.

The image of mask 206 passes through projection lens 208, which focuses the image onto wafer 210. Note that projection lens 208 can include a plurality of lenses configured to achieve a high-NA and other desirable optical properties. During operation, the above-described lithograph system transfers circuitry defined by mask 206 onto wafer 210. Wafer 210 is a semiconductor wafer coated with a thin-film stack. This thin-film stack typically comprises a photoresist layer, or more generally, any layer to be exposed by the system.

Note that illumination source 202 can include a “conventional illumination source” or a “modified illumination source.” A conventional illumination source is a single circular opening which allows most of the illumination to pass through. In contrast, a modified illumination source includes a specially configured metal plate positioned directly in front of a physical light source. More specifically, the metal plate is typically configured with one or more symmetrically arranged apertures or openings to produce a modified illumination effect.

In some embodiments, the modified illumination sources are configured to generate a polarized illumination for enhancing the projected image contrast, and hence the circuit pattern printability. For example, it has been demonstrated that a linearly polarized illumination in the x-direction can facilitate enhancing contrast for a group of line features which are parallel to the x-direction. Consequently, one can configure the illumination source 202 into a “cross-pole illumination source” 212 (shown as an inset of FIG. 2), which includes two opposing apertures on y-axis configured to generate x-polarized illumination, and another two opposing apertures on x-axis configured to generate y-polarized illumination. This way, illumination source 212 can be used to enhance contrast to groups of line features in both x- and y-directions.

In the following discussion, we define the central axis (i.e., the vertical axis) of the lithography system in FIG. 2 as the z-axis. Hence, a plane in the lithography system perpendicular to the z-axis is an x-y plane, including an illumination pupil plane.

### Modeling an Approximated TE-Polarized Illumination Source

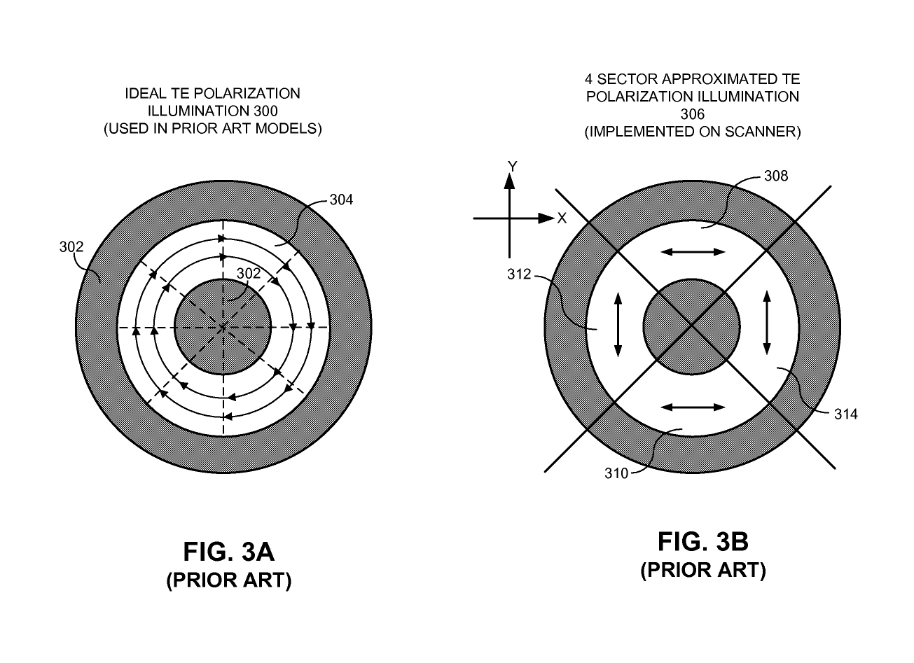

As mentioned previously, TE-polarized illumination sources can achieve excellent image contrast for printing sub-100 nm circuit features. FIG. 3A illustrates an illumination-source model representing an ideal TE-polarized illumination 300. Note that the shaded regions 302 represent metal plates and the bright region 304 represents an opening. We refer to the combined area of the shaded regions 302 and the opening region 304 as “illumination pupil plane” hereafter. As illustrated in FIG. 3A, electrical fields (shown as the circles and the arrows) associated with ideal TE-polarized illumination 300 are in azimuthal directions and perpendicular to the local radii (shown as the dashed lines). Note that the electrical field directions vary continuously from point to point within the opening 304. Unfortunately, physically implementing such an ideal TE illumination is impractical due to hardware limitations. Consequently, scanner manufacturers typically only implement an approximated version of an ideal TE illumination in an illumination source.

FIG. 3B illustrates an approximated TE-polarized illumination source 306 as implemented by some scanner manufacturers. This implementation divides opening region 304 into four substantially equal-sized sectors 308-314. Next, a constant-linear polarization state is implemented within each sector to approximate a TE-polarization within the sector as illustrated in FIG. 3B. More specifically, x-polarization state is implemented within sectors 308 and 310, and y-polarization state is implemented within sectors 312 and 314. Note that this polarization configuration can be readily implemented by installing a specific linear polarizer within each sector of the illumination source, or by using other types of optical devices that can produce a linear polarization.

Hence, the ideal TE-polarized illumination assumed by the model as illustrated in FIG. 3A does not mathematically match the physical implementation of the TE illumination on the real scanner as illustrated in FIG. 3B.

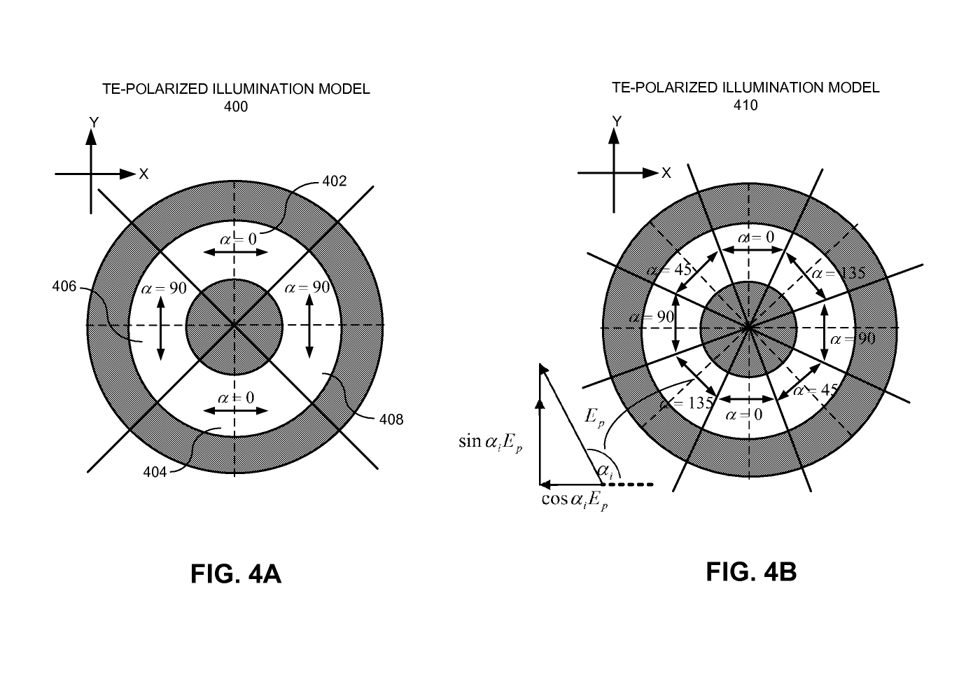

FIG. 4A illustrates the process of constructing a source polarization model 400 to simulate the approximated TE-polarized illumination source 306 in accordance with an embodiment of the present invention. As illustrated in FIG. 4A, the illumination pupil plane is partitioned into four substantially equal-sized circular sectors 402-408 to match the physical partitioning of the illumination source 306 in FIG. 3B. Note that each of the four sectors contains opaque areas of metal plates (shaded areas) and an opening area which allows light to pass through.

Note also that each sector is associated with a constant-linear polarization state represented by a unique polarization angle α which matches the polarization-configuration of the corresponding sectors in the physical implementation 306 in FIG. 3B. In this embodiment, each polarization angle α is measured in x-y coordinates. Hence, sectors 402 and 404 are associated with α=0 degree while sectors 406 and 408 have α=90 degree. Note that these angle values are associated with specific x-y coordinates used by the model. In some embodiments of the present invention, the polarization angle α for a given sector is determined to be in a direction which is substantially perpendicular to a radius bisecting the respective circular sector (the bisecting radii shown as the dashed lines).

Note that the general technique of partitioning the illumination pupil plane to match the physical partitioning of the approximated TE illumination source can be extended to different physical implementations. For example, using eight (instead of four) circular sectors with a constant-linear polarization state in each sector can provide a more accurate approximation of an ideal TE-polarized illumination. FIG. 4B illustrates the process of constructing a source polarization model 410 to simulate an approximated TE-polarized illumination source having eight sectors in accordance with an embodiment of the present invention.

As illustrated in FIG. 4B, the same illumination pupil plane is partitioned into eight substantially equal-sized sectors to match a physical partitioning of an eight-sector approximated TE polarized illumination source. Note that each of the sectors is associated with a constant-linear polarization state represented by the arrow within the sector and a polarization angle α (i.e., two α=0-degree sectors, two α=45-degree sectors, two α=90-degree sectors, and two α=135-degree sectors). In some embodiments of the present invention, the polarization angle α for a given sector is determined to be in a direction which is substantially perpendicular to a radius bisecting the respective circular sector (the bisecting radii shown as the dashed lines).

Note that the constant-linear polarization state of each sector can be mathematically described by a single constant electric field vector Eₚ in the arrow direction. In one embodiment, electric field vector Eₚ within each sector can be decomposed into corresponding x-polarized and y-polarized components:

Eₓ=cos αᵢEₚ and E_{y}=sin αᵢEₚ (1)

based on the associated polarization angle αᵢ, wherein i represents the ith sector. We use this mathematical representation of the constant-linear polarization states to compute the effects of TE-polarized illumination on the image intensity field below.

Although embodiments of the present invention are described in terms of the four-sector partition of FIG. 4A and the eight-sector partition of FIG. 4B, an illumination pupil plane can generally be partitioned into fewer or more circular sectors to match any given physical implementation of an approximated TE-polarized illumination source. Furthermore, the general technique of partitioning an illumination pupil plane and individually specifying polarized illuminations can be used to simulate scanner illuminator designs with a variable number of sectors. In general, increasing the number of circular sectors in the partition can improve the approximated TE-polarized illumination source towards an ideal TE-polarized illumination source.

Note that after constructing the source polarization model for an approximated TE-polarized illumination source, the model can then be used to compute the polarization effect of the illumination source on the lithography and OPC models.

### Modeling a Piecewise-Constant Polarized Illumination Source

Note that the general technique of modeling an approximated TE-polarized illumination source can be applied to modeling any illumination source having a piecewise-constant polarization configuration, and is therefore not limited to simulating TE polarizations.

In some embodiments of the present invention, modeling a piecewise-constant polarization configuration of an illumination source involves first partitioning an illumination pupil plane of the illumination source into a set of sectors to match a physical implementation of the illumination source. Next, a model for the illumination source is constructed by individually specifying a constant polarization-state within each sector to match the polarization configuration of the illumination source. Because the polarization-states do not have to be the same for all sectors, a piecewise-constant polarization configuration model is obtained.

Note that partitioning the illumination pupil plane of the illumination source can involve a radial-sector partition, which is performed along the radial direction of the pupil, a circular-sector partition, which is performed along the azimuthal direction of the pupil, and any other partitioning techniques that are not necessarily performed in a specific direction. For example, the configuration of quadrupole illumination source 212 in FIG. 2 can be considered as a form of a partitioning by “cutting out” sectors from an opaque plane, wherein each cutout sector can have a constant polarization state. Generally, each partitioned sector can have a unique size, geometry, and position within the pupil plane.

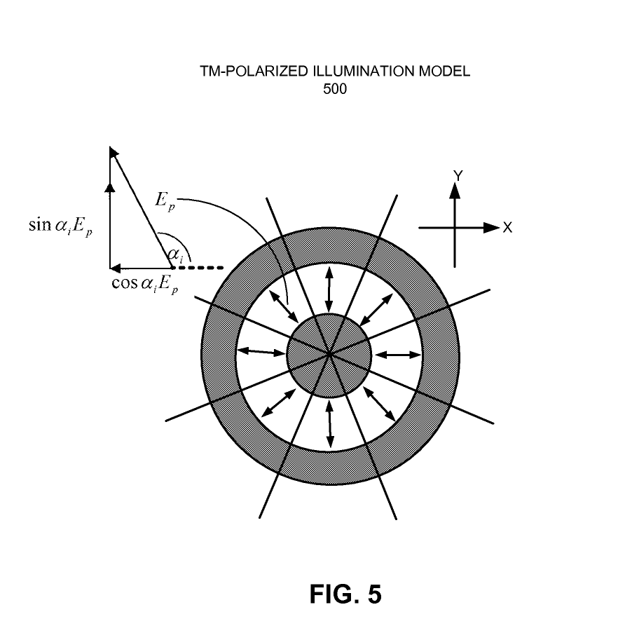

FIG. 5 illustrates the process of constructing a source polarization model 500 to simulate an approximated TM (transverse magnetic)-polarized illumination source in accordance with an embodiment of the present invention. Note that in an ideal TM-polarized illumination, the electrical field direction is parallel to the radial direction at every source location, which is also impractical to physically implement on an illumination source. Consequently, an approximated TM-polarized illumination source can be physically implemented in the same manner as the approximated TE-polarized illumination source in FIG. 3B, except that each sector is now associated with linear polarized illumination along a radial direction.

As seen in FIG. 5, to construct a source polarization model for an approximated TM-polarized illumination source with eight sectors, the illumination pupil plane is also partitioned into eight sectors to match the physical partitioning of the approximated TM-polarized illumination source. In this embodiment, these sectors are also circular sections. Next, a constant-linear polarization state (i.e., a linear polarization along a radial direction) is defined for each sector to match the polarization-configuration of the corresponding sector in the physical implementation of an approximated TM-polarized illumination. Again, each constant polarization state can be mathematically described with a polarization angle αᵢ, and the associated electrical field Eₚ, which can be decomposed into the x-polarized and y-polarized components.

### Computing the Polarization Effect of the Illumination Source

In one embodiment of the present invention, to compute the effects from a piecewise constant polarized illumination source on the image intensity, contribution from each sector is computed individually and the overall effect from the sectorized illumination source is obtained by summing together the individual contributions (on the image intensity) from all the sectors.

In one embodiment of the present invention, the light intensity at the image plane (e.g., on wafer 210 in FIG. 2) due to a particular polarized illumination source component can be computed by using the Hopkins vector imaging equation:

$$I ( x , y ) = \int \int \int \int \int \int J ( f , g ) H ( f + {f}_{1} , g + {g}_{1} ) {H}^{*} ( f + {f}_{2} g + {g}_{2} ) {\sum }_{{i = x , y}_{{j = x , y}_{k = x , y , z}}} {M}_{ik} ( f + {f}_{1} , g + {g}_{1} ) {M}_{jk}^{*} ( f + {f}_{2} g + {g}_{2} ) {E}_{i} {E}_{j}^{*} O ( {f}_{1} , {g}_{1} ) {O}^{*} ( {f}_{2} , {g}_{2} ) {e}^{- i 2 π [ ( {f}_{1} - {f}_{2} ) x + ( {g}_{1} - {g}_{2} ) y ]} d f d g d {f}_{1} d {g}_{1} d {f}_{2} d {g}_{2} . \qquad ( 2 )$$

Note that using the Hopkins vector imaging equation to compute image intensity in OPC/RET modeling is well known in the art, and hence the equation is not discussed in detail herein.

To apply the Hopkins vector imaging equation on the ith sector having a constant-linear polarized field Eₚ and a polarization angle αᵢ, we decompose Eₚ into corresponding x-polarized and y-polarized components Eₓ=cos αᵢ Eₚ and E_{y}=sin αᵢ Eₚ. Next, a coherency matrix J can be computed as:

$$J = [ \begin{matrix} & {E}_{x} {E}_{y}^{*} \\ {E}_{y} {E}_{x}^{*} & {E}_{y} {E}_{y}^{*} \end{matrix} ] = [ \begin{matrix}{cos}^{2} {α}_{i} {E}_{p}^{2} & cos {α}_{i} sin {α}_{i} {E}_{p}^{2} \\ cos {α}_{i} sin {α}_{i} {E}_{p}^{2} & {sin}^{2} {α}_{i} {E}_{p}^{2}\end{matrix} ] , \qquad ( 3 )$$

wherein < > represents a time average operation, the (1,1) entry is related to the x-polarized component, the (2,2) entry is related to the y-polarized component, and the (2,1) and (1,2) entries are related to the coupling between the x- and y-polarized components. The coupling terms are also referred to as the “cross-terms.” Note that coherency matrix representation is applicable to any degree of a polarized light.

Next, the portion of Eqn. 2 which represents modifying the transfer matrix M with the polarized illumination Eᵢ can be explicitly expressed as the sum of the following four terms:

$${\sum }_{k = x , y , z} {M}_{xk} ( f + {f}_{1} , g + {g}_{1} ) {M}_{xk}^{*} ( f + {f}_{2} , g + {g}_{2} ) {E}_{x} {E}_{x}^{*} = {\sum }_{k = x , y , z} {M}_{xk} ( f + {f}_{1} , g + {g}_{1} ) {M}_{xk}^{*} ( f + {f}_{2} , g + {g}_{2} ) {E}_{p}^{2} {cos}^{2} {α}_{i} \\ {\sum }_{k = x , y , z} {M}_{yk} ( f + {f}_{1} , g + {g}_{1} ) {M}_{yk}^{*} ( f + {f}_{2} , g + {g}_{2} ) {E}_{y} {E}_{y}^{*} = {\sum }_{k = x , y , z} {M}_{yk} ( f + {f}_{1} , g + {g}_{1} ) {M}_{yk}^{*} ( f + {f}_{2} , g + {g}_{2} ) {E}_{p}^{2} {sin}^{2} {α}_{i} \\ {\sum }_{k = x , y , z} {M}_{xk} ( f + {f}_{1} , g + {g}_{1} ) {M}_{yk}^{*} ( f + {f}_{2} , g + {g}_{2} ) {E}_{x} {E}_{y}^{*} = {\sum }_{k = x , y , z} {M}_{xk} ( f + {f}_{1} , g + {g}_{1} ) {M}_{yk}^{*} ( f + {f}_{2} , g + {g}_{2} ) {E}_{p}^{2} cos {α}_{i} sin {α}_{i} \\ {\sum }_{k = x , y , z} {M}_{xk} ( f + {f}_{1} , g + {g}_{1} ) {M}_{yk}^{*} ( f + {f}_{2} , g + {g}_{2} ) {E}_{y} {E}_{x}^{*} = {\sum }_{k = x , y , z} {M}_{xk} ( f + {f}_{1} , g + {g}_{1} ) {M}_{yk}^{*} ( f + {f}_{2} , g + {g}_{2} ) {E}_{p}^{2} cos {α}_{i} sin {α}_{i} . \qquad ( 4 )$$

wherein the first two terms are associated with x-polarized and y-polarized components and last two terms are associated with the coupling between the x-polarized and y-polarized components. In one embodiment of the present invention, the above Hopkins vector imaging equation can be implemented using a set of kernels for each sector.

### Process of Modeling a Piecewise-Constant Polarization Configuration

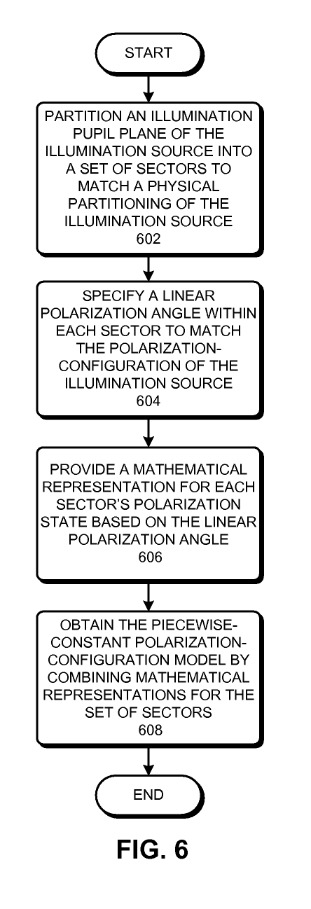

FIG. 6 presents a flowchart illustrating the process of modeling a piecewise-constant polarization-configuration of an illumination source in accordance with an embodiment of the present invention.

During operation, the system partitions an illumination pupil plane of the illumination source into a set of sectors to match the shapes of the physical implementation of the illumination source (step 602). In some embodiments, the physical partitioning information can be obtained from scanner manufacturers or by analyzing the measured illumination profile of the illuminator.

Next, the system specifies a constant-linear polarization angle within each sector to match the polarization-configuration of the illumination source (step 604). The system then provides a mathematical representation for each sector's polarization state based on the polarization angle (step 606).

The system then obtains the piecewise-constant polarization model of the illumination source by combining mathematical representations for the set of sectors (step 608). Note that this piecewise-constant polarization model mathematically matches the physical implementation of the piecewise-constant polarization illumination.

Note also that the system can subsequently incorporate the piecewise-constant polarization model of the illumination source into an overall optical lithography model. In some embodiments, this can be accomplished by using the Hopkins vector imaging equation.

### Modeling an Arbitrary Illumination Configuration of an Illumination Source

Note that the general technique of modeling an approximated TE-polarized illumination source can also be used to model an arbitrary illumination and polarization-configuration of an illumination source. More specifically, an arbitrary illumination and polarization-configuration may include regions with polarized illumination states, partially polarized illumination states, unpolarized illumination states (i.e., incoherent x- and y-polarizations of equal intensity), and a combination of the above.

In some embodiments of the present invention, modeling an arbitrary illumination and polarization-configuration of an illumination source involves first partitioning an illumination pupil plane of the illumination source into a set of sectors to match a physical implementation of the illumination source. Note that any of the above-described partitioning techniques can be used herein. Next, a model for the illumination source is constructed by individually specifying an illumination polarization-state within each sector to match the illumination and polarization-configuration of the illumination source. Note that the illumination polarization-state within each sector can include a linear polarization state, a partial polarization state, and an unpolarized state.

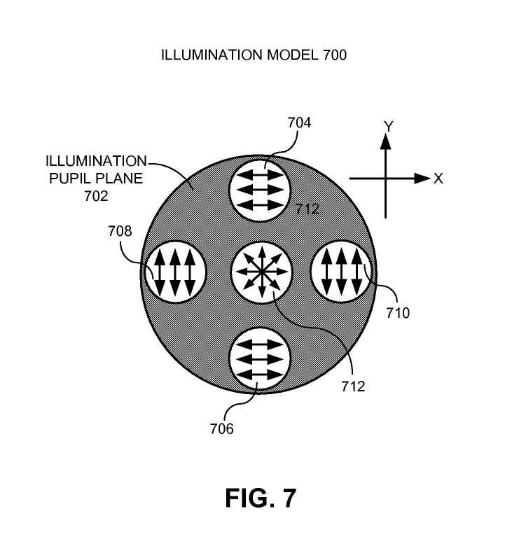

FIG. 7 illustrates the process of constructing an illumination model 700 to simulate a polarized illumination source comprising both linear polarized and unpolarized regions in accordance with an embodiment of the present invention. As illustrated in FIG. 7, an illumination pupil plane 702 is partitioned into five circular apertures (or “poles”) 704-712 by cutting out regions from an opaque plate. Next, x-polarization states are specified inside poles 704 and 706 while y-polarization states are specified inside poles 708 and 710. Note that this polarization configuration for poles 704-710 is similar to an approximated TE-polarization illumination source model in FIG. 4A. Optionally, an unpolarized illumination state is specified within center pole 712. Hence, the combined illumination from illumination pupil plane 702 comprises partially an approximated TE-polarized illumination and partially an unpolarized illumination.

Note that the embodiment of FIG. 7 is used for the illustration purposes. In general, an arbitrary illumination and polarization configuration can include any combination of one or more of: a linear polarization state, a circular polarization state, an elliptical polarization state, a partial polarization state, and an unpolarized state.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for constructing a source polarization model to simulate a physical implementation of a transverse electric (TE)-polarized illumination source in an optical lithography system, the method comprising:
partitioning an illumination pupil plane of the illumination source into a set of sectors to match a physical implementation of the illumination source; and
for each sector,
defining a constant-linear polarization angle which is substantially perpendicular to a radius bisecting the sector; and
providing a mathematical representation for a linear polarization state within the sector based on the corresponding linear polarization angle.

2. The method of claim 1, wherein partitioning the illumination pupil plane of the illumination source involves partitioning the illumination pupil plane into four substantially equal circular sectors.

3. The method of claim 2, wherein defining a constant-linear polarization angle for each of the four substantially equal circular sectors involves:
defining x-polarization states for the pair of opposing circular sectors on Y-axis; and
defining y-polarization states for the pair of opposing circular sectors on X-axis.

4. The method of claim 1, wherein partitioning the illumination pupil plane of the illumination source involves partitioning the illumination pupil plane into eight substantially equal circular sectors.

5. The method of claim 1, wherein the method further comprises increasing the number of sectors in the partition to better approximate an ideal TE-polarized illumination source.

6. The method of claim 1, wherein the method further comprises incorporating the source polarization model for the illumination source into a model for the optical lithography system or for Optical Proximity Correction (OPC).

7. The method of claim 6, wherein incorporating the source polarization model into the lithography model involves:
computing an effect from each sector in the source polarization model on the lithography model; and
combining the computed effects of the set of sectors into the source polarization model.

8. A method for constructing a source polarization model to simulate a physical implementation of a transverse magnetic (TM)-polarized illumination source in an optical lithography system, the method comprising:
partitioning an illumination pupil plane of the illumination source into a set of sectors to match a physical implementation of the illumination source; and
for each sector,
defining a constant-linear polarization angle which is substantially parallel to a radius bisecting the sector; and
providing a mathematical representation for a linear polarization state within the sector based on the corresponding linear polarization angle.

9. A method for constructing a source polarization model to simulate a piecewise-constant-linear polarization-configuration of an illumination source in an optical lithography system, the method comprising:
partitioning an illumination pupil plane of the illumination source into a set of sectors to match a physical implementation of the illumination source; and
constructing the source polarization model for the illumination source by individually specifying a constant-linear polarization-state within each sector to match the polarization-configuration of the illumination source.

10. The method of claim 9, wherein partitioning the illumination pupil plane of the illumination source into a set of sectors can involve:
a radial-sector partition; and
a circular-sector partition; and
other partitions with specific sector shape and positioning.

11. The method of claim 9, wherein the piecewise-constant-linear polarization-configuration of the illumination source can include:
an approximated TE-polarization-configuration;
an approximated TM-polarization-configuration; and
any other piecewise-constant-linear polarization-configuration.

12. The method of claim 9, wherein specifying a constant-linear polarization-state within each sector involves:
specifying a linear polarization angle within the sector; and
providing a mathematical representation for a linear polarization state within the sector based on the linear polarization angle.

13. The method of claim 9, wherein the method further comprises incorporating the source polarization model for the illumination source into a model for the optical lithography system or for Optical Proximity Correction (OPC).

14. The method of claim 13, wherein incorporating the polarization model into the lithography model involves:
computing an effect from each sector in the source polarization model on the lithography model; and
combining the computed effects from the set of sectors into the source polarization model.

15. A method for constructing a model to simulate an arbitrary illumination and polarization-configuration of an illumination source in an optical lithography system, the method comprising:
partitioning an illumination pupil plane of the illumination source into a set of sectors to match a physical implementation of the illumination source; and
constructing the model for the illumination source by individually specifying an illumination polarization-state within each sector to match the illumination and polarization-configuration of the illumination source.

16. The method of claim 15, wherein the illumination polarization-state within each sector can include:
a linear polarization state;
a partial polarization state; or
an unpolarized state.

17. The method of claim 15, wherein partitioning the illumination pupil plane of the illumination source into a set of sectors can involve:
a radial-sector partition; and
a circular-sector partition; and
other partitions with specific sector shape and positioning.

18. A computer-readable storage medium storing instructions that when executed by a computer cause the computer to perform a method for constructing a source polarization model to simulate a physical implementation of a transverse electric (TE)-polarized illumination source in an optical lithography system, the method comprising:
partitioning an illumination pupil plane of the illumination source into a set of sectors to match a physical implementation of the illumination source; and
for each sector,
defining a constant-linear polarization angle which is substantially perpendicular to a radius bisecting the sector; and
providing a mathematical representation for a linear polarization state within the sector based on the corresponding linear polarization angle.

19. The computer-readable storage medium of claim 18, wherein partitioning the illumination pupil plane of the illumination source involves partitioning the illumination pupil plane into four substantially equal circular sectors.

20. The computer-readable storage medium of claim 19, wherein defining a linear polarization angle for each of the four substantially equal circular sectors involves:
defining x-polarization states for the pair of opposing circular sectors on Y-axis; and
defining y-polarization states for the pair of opposing circular sectors on X-axis.

21. The computer-readable storage medium of claim 18, wherein partitioning the illumination pupil plane of the illumination source involves partitioning the illumination pupil plane into eight substantially equal circular sectors.

22. The computer-readable storage medium of claim 18, wherein the method further comprises increasing the number of sectors in the partition to better approximate an ideal TE-polarized illumination source.

23. The computer-readable storage medium of claim 18, wherein the method further comprises incorporating the source polarization model for the illumination source into a lithography model for the optical lithography system or for Optical Proximity Correction (OPC).

24. The computer-readable storage medium of claim 23, wherein incorporating the source polarization model into the lithography model involves:
computing an effect from each sector in the source polarization model on the lithography model; and
combining the computed effects of the set of sectors into the source polarization model.

25. A computer-readable storage medium storing instructions that when executed by a computer cause the computer to perform a method for constructing a source polarization model to simulate a physical implementation of a transverse magnetic (TM)-polarized illumination source in an optical lithography system, the method comprising:
partitioning an illumination pupil plane of the illumination source into a set of sectors to match a physical implementation of the illumination source; and
for each sector,
defining a constant-linear polarization angle which is substantially parallel to a radius bisecting the sector; and
providing a mathematical representation for a linear polarization state within the sector based on the corresponding linear polarization angle.

26. A computer-readable storage medium storing instructions that when executed by a computer cause the computer to perform a method for constructing a source polarization model to simulate a piecewise-constant-linear polarization-configuration of an illumination source in an optical lithography system, the method comprising:
partitioning an illumination pupil plane of the illumination source into a set of sectors to match a physical implementation of the illumination source; and
constructing the source polarization model for the illumination source by individually specifying a constant-linear polarization-state within each sector to match the polarization-configuration of the illumination source.

27. The computer-readable storage medium of claim 26, wherein partitioning the illumination pupil plane of the illumination source into a set of sectors can involve:
a radial-sector partition; and
a circular-sector partition; and
other partitions with specific sector shape and positioning.

28. The computer-readable storage medium of claim 26, wherein the piecewise-constant-linear polarization-configuration of the illumination source can include:
an approximated TE-polarization-configuration;
an approximated TM-polarization-configuration; and
any other piecewise-constant-linear polarization-configuration.

29. The computer-readable storage medium of claim 26, wherein specifying a constant-linear polarization-state within each sector involves:
specifying a linear polarization angle within the sector; and
providing a mathematical representation for a linear polarization state within the sector based on the linear polarization angle.

30. The computer-readable storage medium of claim 26, wherein the method further comprises incorporating the source polarization model for the illumination source into a model for the optical lithography system or for Optical Proximity Correction (OPC).

31. The computer-readable storage medium of claim 30, wherein incorporating the source polarization model into the model involves:
computing an effect from each sector in the source polarization model on the lithography model; and
combining the computed effects from the set of sectors into the source polarization model.

32. A computer-readable storage medium storing instructions that when executed by a computer cause the computer to perform a method for constructing a model to simulate an arbitrary illumination and polarization-configuration of an illumination source in an optical lithography system, the method comprising:
partitioning an illumination pupil plane of the illumination source into a set of sectors to match a physical implementation of the illumination source; and
constructing the model for the illumination source by individually specifying an illumination polarization-state within each sector to match the illumination and polarization-configuration of the illumination source.

33. The computer-readable storage medium of claim 32, wherein the illumination polarization-state within each sector can include:
a linear polarization state;
a partial polarization state; or
an unpolarized state.

34. The computer-readable storage medium of claim 32, wherein partitioning the illumination pupil plane of the illumination source into a set of sectors can involve:
a radial-sector partition; and
a circular-sector partition; and
other partitions with specific sector shape and positioning.
